(19) United States
(12) Patent Application Publication
(10) Pub. No.: US 2009/0325135 A1
(43) Pub. Date: Dec. 31, 2009

(54) Dental clinical and simulation training tracking system and its method of evaluation

(75) Inventors: Ta-Ko Huang, Taipei (TW); Chun-Cheng Hung, Taipei (TW)

Correspondence Address: BIRCH STEWART KOLASCH & BIRCH, PO BOX 747, FALLS CHURCH, VA, 22040-0747, US

(73) Assignee: EPED INC.

(21) Appl. No.: 12/216,067

(22) Filed: Jun. 27, 2008

(51) Int. Cl. G09B 23/30

(52) U.S. Cl. 434/264

(57) ABSTRACT

A dental clinical and simulation training tracking system which can be associated with a hand tool having multiple tabs to determine its position and a positioning unit having multiple marks to establish the coordinate. The system includes at least a hand tool socket, which can be associated with a hand tool, having multiple tabs to determine its position, a positioning unit, having multiple marks to establish the coordinate system, and an optical positioning module, which is used to detect the position and angle of the hand tool socket and the position of the positioning unit to track their relative displacement, establishing the evaluation rules and fulfilled the goal of evaluation.

### TECHNICAL FIELD

The invention is about a device and a method of dental clinical training tracking system, specifically a coordinate system using optical properties which could help measure a hand tool area and score the dental clinical teaching and training of tracking system of users and the evaluative method.

### BACKGROUND ART

The training method of making a dental model is to set the objective dental model by the side as a contrast, and carve the dental model in the oral mannequin by hand tools at the same time. After taking the completed dental model made by the students, the cut shapes and sizes are judged by the interns according to their naked eye to see if they have reached the standard.

The judgment based on homophyly would be too subjective because the dental model is different in every single human being. Compared to the traditional methods, the optical tracking method would have much more objective results for analysis of deviations. As the medical school students carved the dental models using the hand tools, the optical tracking method would track the tool's position at the same time. It would deduce the dental model shape, as carved by those students, by using mathematical methods.

There are already some techniques for tracking the position of medical equipment in prior art. For example, the invention named “Imaging System Having Interactive Medical Instruments And Methods,” approved by the USPTO to Chander on Apr. 8, 1997, USPTO U.S. Pat. No. 5,617,857, exposed an imaging system and its methods. This imaging system includes a medical equipment subject and an ejector whose energy was detectable while ejecting. Making further efforts, they can use a detector and a processor to detect the position of the medical equipment.

On Jan. 6, 2004, the USPTO granted the patent named “Optical Object Tracking System,” USPTO U.S. Pat. No. 6,675,040, which exposed an optical detective system that is used to record the position of detectable equipment in space. Several cameras are connected to a data processor, image scanning data, a computer and a patterning indicator that could search for equipment, target goals, patients and the position of the device in surgical operation, diagnosis and cure.

The USPTO granted two U.S. Pat. Nos. 6,351,659 and 6,859,660 to Vilsmeier on Feb. 26, 2002 and Feb. 22, 2005 respectively, named “Neuro-Navigation System,” which exposed a neuro-navigation system and a reflective device reference system. This reference system has an initiative reflector and a marking system which are accessorized in patients' bodies and surgical equipments, which could help determine its position correctly.

The USPTO granted to Vilsmeier the patent “Method And Device For The Navigation-Assisted Dental Treatment,” USPTO U.S. Pat. No. 6,640,128, on Oct. 28, 2003, which exposed an assistant method of a clinical dental cure. First, three-dimensional volume data from a patient's teeth or the lower jaw would be provided. A computer assistant navigation system or tracing system would then use the volume data to record the patient's teeth or the lower jaw. Compared to the navigation or tracing system, the medical equipment or device would be recorded on a computer.

Therefore, the prior art described above cannot collocate our existing dental equipments and upgrade. For example, it is unable to collocate the existing dental operating table and hand tools. It is also unable to adjust by using the operated habits from every single user. It is inconvenient to seek for help from existing personal computers to determine the position of the equipment. Furthermore, to correct the position which caused the system rearrangement is costly and restricts the ability to market.

So a motive tracing device, which could make a three-dimensional image by using a low-cost camera, can upgrade the existing equipment and be able to suit the user's operating habits (i.e. right-handed or left-handed). It can also improve the traditional method of depending on human eyesight by using automatic methods instead. The existence of the invention is necessary for the accuracy and convenience in the dentist training program.

### SUMMARY OF THE INVENTION

The goal of this invention is to provide a dental clinical and education training simulation tracking system. Using optical tracking methods, two cameras and a laser emission unit are combined to carry out the localization. Together with the use of space orientation techniques, the image processing procedures can be simplified. This helps track the position of the hand tools used by the dentists when carving the dental model. Moreover, the usage progress savings can improve the inadvertence.

The other goal of this invention is to provide a dental clinical and education training simulation system. Except for the use of connecting the present simulation or clinical system to this dental clinical and education training simulation tracking system for upgrading, it can also be used for training, operation, and judgment of the clinical dentists. The application of this system does not need the replacement of any system or equipment. It can highly reduce costs, and is easily applied to the use of education training. In order to reach the goals described above, this tracking system can be used to trace the user using hand tools, including a hand tool socket, a locating unit, an optical locating module, an information analyzing device, and a monitoring unit. The hand tool socket is used to adapt the hand tool to the system and has plural locating points. The locating unit is used to locate the hand tools, and has many marking points and a hanging structure that can fix the unit on a dental model. The optical locating module is used to detect the location and angular magnitude of the hand tool adapter, as well as the location of the location unit, so one can track the relative displacement of a hand tool and the operating area. This optical locating module comprises at least two cameras: one pointing to the locating unit and one pointing to the hand tool adapter. They are connected to the information analyzing device in order to generate images according to the marking points of the locating unit and the locating points of the hand tool adapter. A laser emission unit is connected to the information analyzing device, and can send out beams to define certain areas. An information analyzing device is used to analyze all the signals made by different components of the system, to establish all the relative coordinate points of the operating process, and to save the progress and results of the movement simulation. A monitoring unit is used to reveal the movements, location of the hand tool, and the judgment results of the users operating the system.

Using this system, we can replace the traditional artificial comparison with an automatic way. We can also reduce negligence of subjective judgment. One can find mistakes more accurately and conveniently in dentist training. Repeated practice can also be carried out easily to promote the developmental education of dentists. This method can be applied through the following steps. First, establish the file of the objective dental model using the dental clinical and education training simulation tracking system. After quantification of the file done by the system, check if there are any severe problems. After checking that there are no mistakes, retrieve a certain code and a standard file of dental model from the database, and a cross-section comparison image will be generated. Find out the setting characteristic marker of the standard dental model, and then calculate the accordance degree of the standard model with the code. Determine if it is necessary to retrieve another suitable code, and calculate the judgment results. In order to manifest the goals, characters, and advantages mentioned above of this invention, we have listed the better application examples in the following, together with the attached figures, to illustrate in detail.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, wherein:

FIG. 1 is the device drawing of the dental clinical and simulation training tracking system of this invention;

FIG. 2 is a diagrammatic sketch for the hand tool socket of this invention;

FIG. 3 is the distributive diagram of the positions from the hand tool socket of this invention;

FIG. 4 is a diagrammatic sketch for the position unit of this invention;

FIG. 5 is a diagrammatic sketch for the combination of the position unit and the hand tool socket of this invention;

FIG. 6 is a flow chart for the method exposed in this invention of building up a coordinate system;

FIG. 7 is an applicable diagrammatic sketch for the dental clinical and stimulation training tracking system of this invention;

FIG. 8 is a flow chart for building up the scored principle of the scored method in dental clinical procession and simulation tracking system of this invention; and

FIG. 9 is a flow chart for building up the scored principle of the scored method in dental clinical and simulation teaching training tracking system of this invention.

### DETAILED DESCRIPTION OF THE PREFERRED EMBODIMENTS

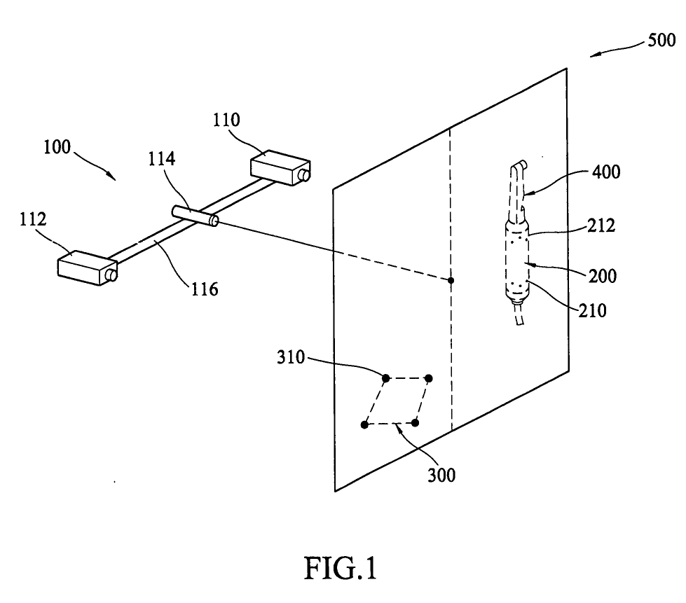

Referring to FIG. 1, it illustrates a dental clinical and simulation training tracking system diagram. As illustrated, this dental clinical tracing device [500], including optical position module [100], a position unit [300], a hand tool [400], a hand tool socket [200], is connected to the information processing unit and revealing unit which are not illustrated in FIG. 1.

The optical position module [100] includes at least two cameras [11 0& 112] to aim at the position unit [300] and hand tool socket [200] and is connected to the information processing device to gain the marked point [310] on the position unit [300] and the position unit on the hand tool socket [200], and then produces an image including a laser emission unit [114] which ejects laser light to define the chosen area. The laser emission unit [114] is also connected to the information processing device. These two cameras [110&112] are also fixed in the two sides of the lateral axis [116]. Besides, in this embodiment; the lateral axis [116] could adjust to the left and right sides of, or up and down from the users' habits and the operating requirements, which makes a better location in the optical position on the two cameras [110&112], and the laser emission unit [114]. The laser emission is located between the camera [110] and the camera [112], which could promote the efficiency of the optical position module by cutting the range that is detected by the two cameras [110 &112].

The position unit [300] equips multiple marked points [310] and a hanging structure which could fix on a teeth and upper and lower jaw model [510] and one of the tooth model's two sides, locating the teeth model as an operating area. Worthy of mention, this position unit [300] successfully achieves corresponding located function while choosing to fix on the different side of the teeth and upper and lower jaw model [510]. Therefore, this equipment is suitable for the operating habits from different users (i.e. habitual practice of right or left hand) without affecting the position efficiency. Besides, there are four light emitting diodes (LED) or marked point [310] engendered by the optical reflective mark. This teeth and upper and lower jaw model [510] can set up the motion and the position of the hand tool socket through the coordinate axis of the position unit [300] and a batch of registration function.

The hand tool [400] is attached to the hand tool socket [200], with the hand tool barrel having multiple fixed points, and the motion of hand tool [400] is measured relatively by the hand tool socket [200]. The hand tool [400] is made for dental clinical practice. It may be an electronic or air powered drill, a hand drill required by dental practice, and it may be other clinical utilities of dental needs. By fixing the hand tool to the hand tool socket [200], the expense incurred by replacing the whole set of particular hand tools is avoided, therefore reducing the cost and increasing the possibility of system practice.

Information processing devices process all signals passed between each component, construct a relevant coordinate throughout the handing duration, and store all the processes and results of motion emulation. An algorithm used in an optical fixation module may be used to read the information returned by the camera [100 & 112], according to a certain algorithm required by this invention, to measure the location of the hand tool socket [200] and the motion status of the hand tool [400] in the jaw model manipulation area, and realize the objectives of this invention. Furthermore, there is a rendering unit to render the evaluated result in the hand tool's motion, fixation and user manipulation.

It is worth mentioning that the information processing device utilizes a personal computer and a video capture card, which is connected to the said cameras [100 & 112], and installs software with functions to realize the certain algorithm function within the personal computer. The laser emission unit [114] is connected to the personal computer via a USB interface, which provides the power required by the laser emission unit [114] and connects it to the information processing unit. The information processing unit then sends the information to the rendering unit, and visualizes the coordination relation of fixation, or renders the evaluated results in the rendering unit.

It is worth noting, the foregoing embodiment only mentions the invocation of this invention but lacks the dental clinical and teaching training stimulation tracking system. The dental clinical and teaching training stimulation tracking system includes a clinical processing tracking device [500], a teeth and upper and lower jaw model [510], a indication unit [520], a lamp-arm group [530] and a brightening unit [540]. However, equipment such as the hand tool [400], the indication unit [520], the lamp-arm group [530] and the brightening unit [540] are usually prepared in the known dental clinical equipment. Therefore, it is the plan of the design of the present invention to process the dental clinical processing tracking device [500] assorted in pairs to existing clinical equipment without the need for buying or changing the existing set of dental equipment. Thus, existing equipment can extend the scope of its original efficacy, or realized the scope of the present invention together with the dental clinical processing stimulation tracking device [500] which could upgrade the existing stimulation or tracking system by connected this dental clinical processing stimulation tracking device.

In addition, this invention provides a function which lets dentists compare and assess the training of the dentists of this dental clinical and teaching training stimulation tracking system, and even in practice application. Through the characteristic of the transposition of the lamp-arm and the position unit, this invention is already suitable for special processing habits from every single user without any adjustment.

For actualizing the position mentioned above, it is started from the optical images retrieved by the camera [110] and camera [112] of the dental clinical teaching training stimulation system, and after a series of operation to calculate the space position of the position unit [300] and the hand tool socket [200]. Find the correlation between the position unit [300] and the hand tool socket [200], and choose the position unit [300] as a standard to get the relative position of the hand tool socket[200]. Finally, load the registration coordinate for converting to the position of the hand tool [400].

The lamp-arm group is a position fixed in the optical position module [100]. The brightening unit [540] is fixed on the lamp-arm, providing the light source to the dental clinical and teaching training stimulation tracking system.

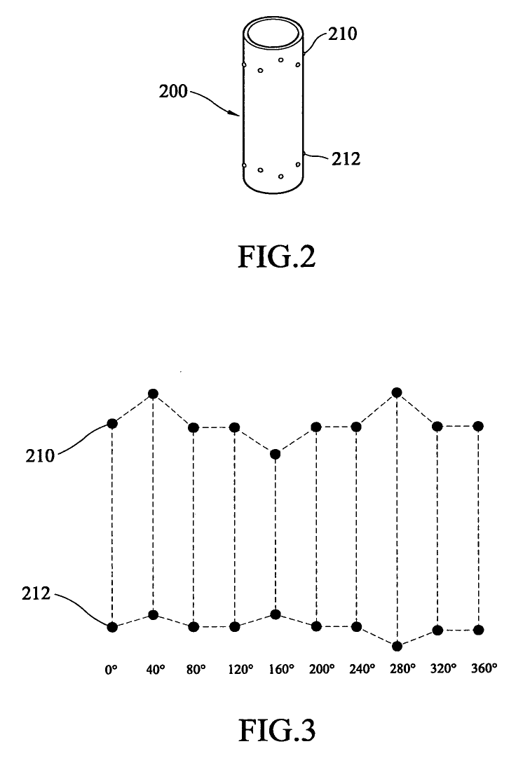

Referring to FIG. 2, it is a diagrammatic sketch of hand tool socket of this invention. The appearance of the hand tool socket [200] is cylindrical-shaped, so that this equipment could combine with the hand tool [400]. Therefore, we can get the hand tool's position while the position of the hand tool socket [200] is decided by the optical position module [100].

As illustrated in FIG. 2, the multiple positions could be separate as a group of superior position [210] and a group of inferior position [212]. Those positions could have particular wavelength light sources, which could set a light emitting diode (LED). According to the particular embodiment of this invention, the light emitting diode (LED) could be replaced by an ultra-red light emitting diode (LED) or an optical reflected mark. According to another embodiment of this invention, the hand tool socket [200] has eighteen marked points in the group of the superior position [210], and eighteen marked points in the group of the inferior position [212], which all are well-distributed around the hand tool socket [200], for instance, every forty degrees for one marked point. Therefore, in every angle of view, it could see at least three marked points in the group of the superior position [210] and three marked points in the group of the inferior position [212]. Besides, the positions of the superior position [210] and of the inferior position [212] are cyclically arranged. Those positions are not placed in the straight line but instead of crossing arrangement or irregular arrangement which could avoid the superior or inferior light emitting diode (LED) shaded at the same time.

Please illustrate FIG. 3. which is an exploring diagram of the lateral position of the hand tool socket [200]. FIG. 3 is a distributive diagram of the position of the hand tool socket in this invention. As illustrated in this diagram, the hand tool socket has a particular geometric arrangement. The corresponding points of the superior and the inferior position are a pair of position. The optical position module [100] could get three pairs of bright dots or more. According to the arrangement in FIG. 3, it is definable what is superior and what is inferior or even what degree of the bright dot located. From that, it is definable for the rotated direction and position in the coordinate system of the hand tool socket [200] which located between the two cameras [110 & 112]. After informing the position of the referable coordinate system and the hand tool socket [200], it could convert the position of the hand tool socket [200] to the referable coordinate system.

According to the description above, one skilled in the art would realize easily that the optical position module [100] could calculate the three-dimension position of the hand tool socket [200] by the group of the superior position [210] and the group of the inferior position [212]. Moreover, we could calculate the location and the angle of the hand tool [400] by using geometric data about the hand tool socket [200] which is already entering the information processing device.

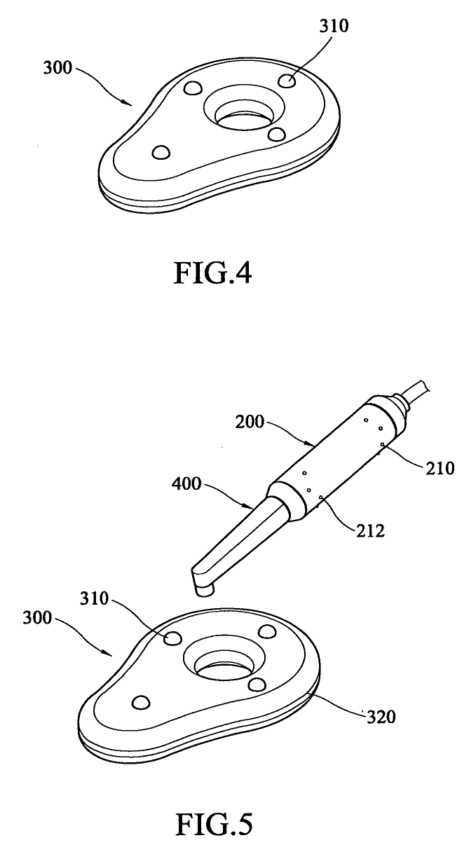

Please illustrate FIG. 4. FIG. 4 is a diagrammatic sketch of the position unit [300] of this invention. One skilled in the art would realize that a patient's head might have some movement while carving the teeth model. For accuracy tracing the position of the teeth, the position unit [300] is set up in the gums of the patient. Moreover, there are multiple marked points [310] on the position unit [300]. For example, there are four marked points [310] on it. There are four light emitting diodes (LED) set on the marked point [310]. It could be the ultra-red light emitting diodes (LED) as well. Therefore, the optical position module [100] could trace the position of the position unit [300], and calculate the relative position of the position unit [300] and the hand tool of the dentist as well.

FIG. 5 is the diagram of the combination of the locating unit and the hand tool socket. It shows the application of the locating unit [300] on the hand tool [400] in the registration of the operating area. See FIG. 5: There are four marking points [310] on the locating board [320] of the locating unit [300]. There is a small hole in the middle of the marking point [310], which fits the size of the drill of the hand tool [400] that can let the drill pass through. A fixing stand can be added to the locating unit to support the hand tool [400]. Adjust the height so that the end drill of the hand tool can pass through the hole in the middle. Fix the end phase of the hand tool immediately next to the locating unit [300], and the drill should be vertical to the reference coordinate board. Locate one time with the optical locating module [100]. Get the light point of the far-red light LED lamp or the optical reflecting mark on the reference locating unit [300] and the hand tool socket [200]. Calculate the relationship of the relative position and to locate the drill on the hand tool socket [200]. Then register the operating area and the locating unit. Note that the operating area and the locating unit [300] should not affect the optical locating module getting the far-red light LED. And the relative position between the operating area and the locating unit remains constant.

In this example, the computer 3D vision model has been established, and can be displayed on the monitoring unit. The computer 3D vision model and the real operating area have many corresponding standard points. So the proofread position of the end drill can be used in this example. Locate some standard points on the real operating area and calculate the position of the space points related to the locating unit. After getting the position of some space points, the position coordinate of the computer 3D operating area model can be transferred into the corresponding position in the real operating area. And the registration of the operating area and the locating unit 300 is completed.

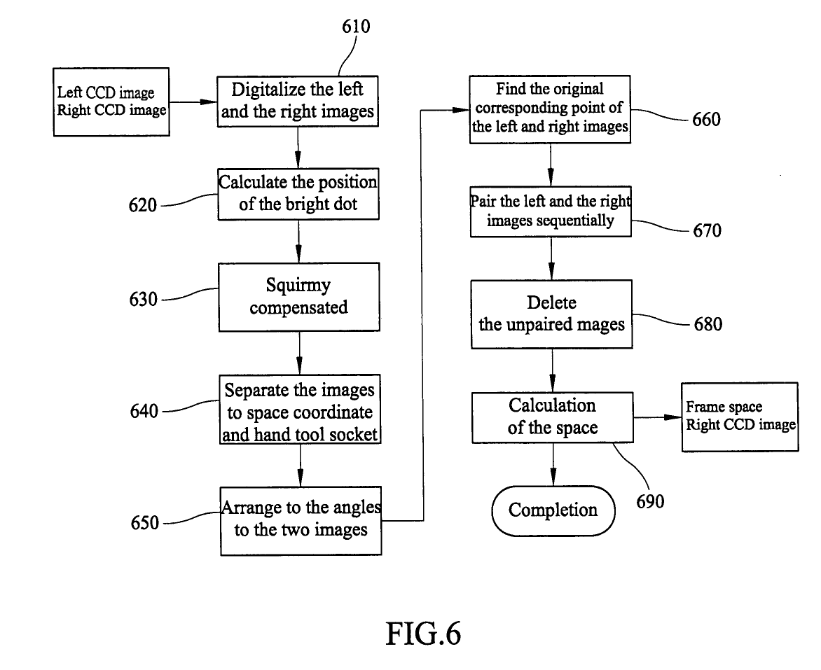

FIG. 6 is a coordinate system processing method exposed in this invention. Before processing the coordinate system, first we have to calculate the space position of every marked point [310]. The major flow chart is illustrated in this diagram, including the following steps:

First digitalize the left and the right images [step 610], that is to say, digitalize the right and left images cut by the laser emission unit [114]. And then calculate the position of the bright dot [step 620], and squirmy compensated [step 630] to the image position, as well as the defective compensation. Separate the images to space coordinate and hand tool socket [step 640], arrange the angles to the two images [step 650], find the original corresponding point of the left and right images [step 660], pair the left and the right images sequentially [step 670], delete the unpaired images [step 680], and finally accomplish the calculation of the space coordinate and the hand tool socket at.

Through the steps mentioned above, we can calculate the reference coordinate and the position of the marked point [310] of the hand tool socket [200]. After calculation, we can separate the marked points of the reference coordinate and hand tool socket [200]. Next, calculate the position of the reference coordinate by some programs.

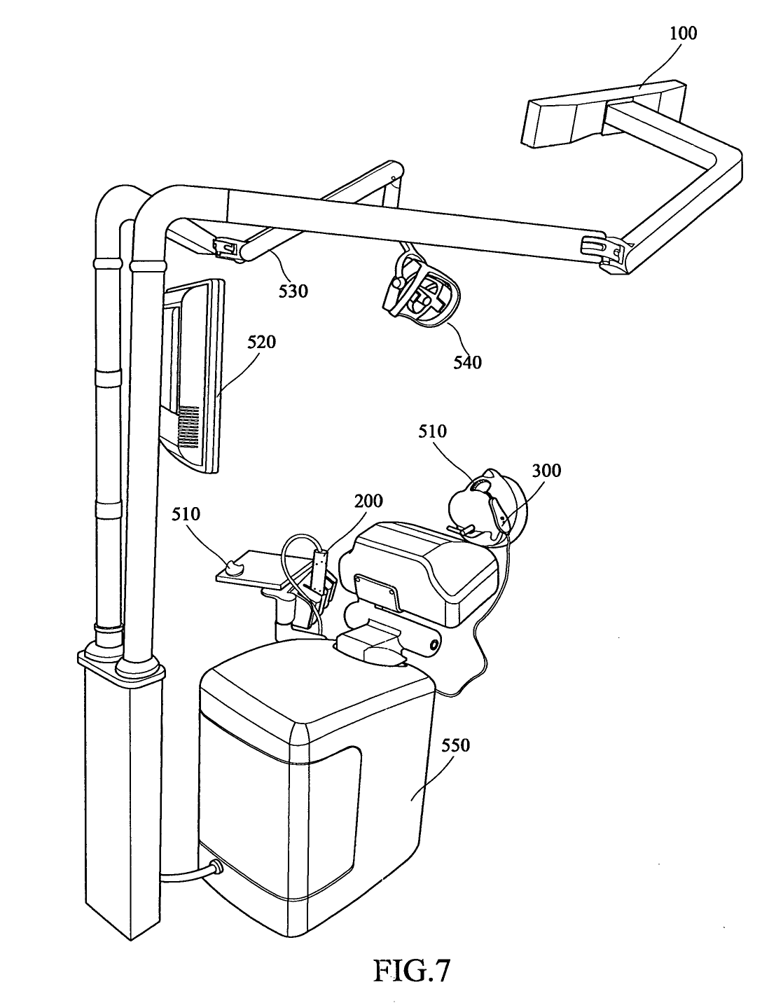

FIG. 7 is an application diagram of the present invention. As illustrated in FIG. 7, the system comprises an optical position module [100], a hand tool socket [200], a position unit [300], a hand tool [400], a teeth jaw module [510], a displaying unit [520], a lamp arm set [530], a light unit [540], and a base [550]. All relating elements mentioned in this paragraph are disclosed there before so that all repeated descriptions are omitted.

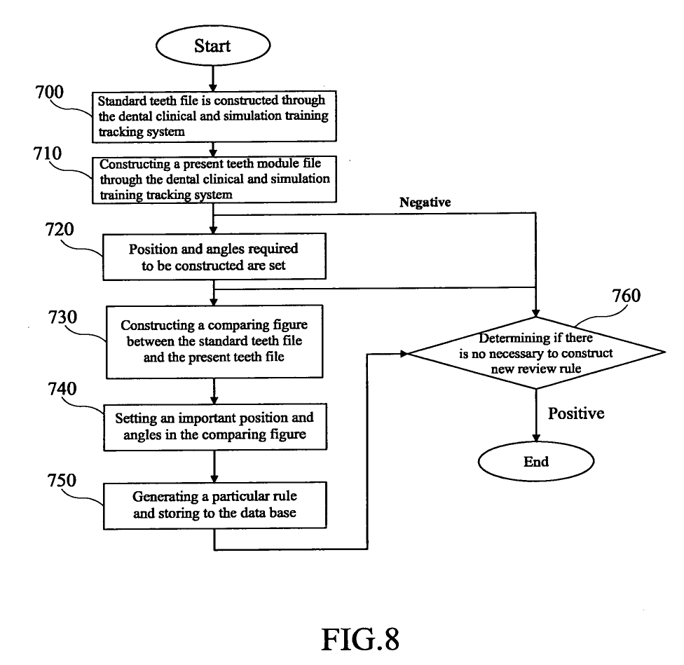

FIG. 8 is a flow chart of the review method for the detailed practice operation tracking of the present invention.

As illustrated, firstly, a standard teeth file is constructed through the dental clinical and simulation training tracking system (step 700). After constructing, construct a present teeth module file through the dental clinical and simulation training tracking system (step 710). Next, a position and angles are required to be constructed are set. After confirmation, construct a comparing figure between the standard teeth file and the present teeth file (step 730). Set an important position and angles in the comparing figure (step 740). Generate a particular rule and store to the database (step 750). Finally, determine if it is necessary to construct a new review rule (step 760). If it is necessary, go to step 720. If not, end this flow chart.

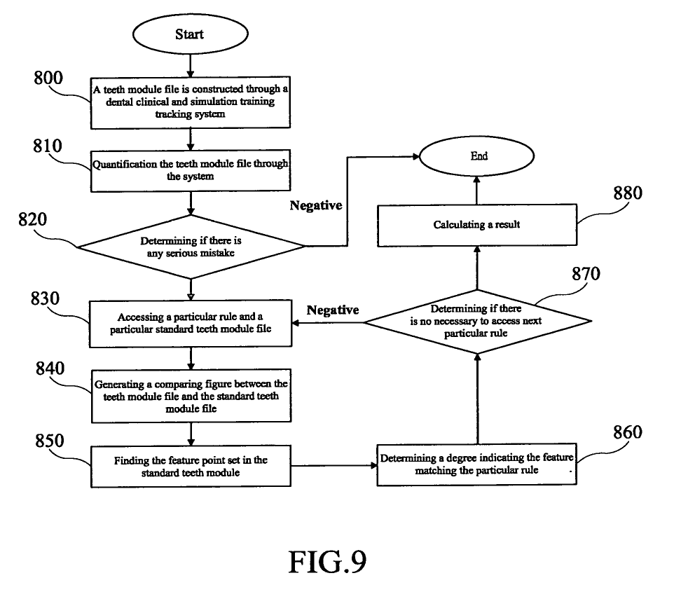

Please refer to FIG. 9. FIG. 9 is a flow chart of the present invention.

As illustrated in FIG. 9, firstly, a teeth module file is constructed through a dental clinical and simulation training tracking system (step 800). Then quantification of the teeth module is filed through the system (step 810). After that, determine if there is any serious mistake (step 820). A serious mistake means one of the below situations is present in the scraping process: injuring neighboring teeth, injuring pulp of the teeth, and scraping an area beyond the teeth. If there is a serious mistake, the flow chart is ended. If there is no serious mistake, access a particular rule and a particular standard teeth module file (step 830), then generate a comparing figure between the teeth module file and the standard teeth module file (step 840). The flow chart emphasizes a scraping amount, a scraping degree and a scraping angle. Next, find the feature point set in the standard teeth module (step 850). The feature is defined according to each of the particular different rules. After finding the feature, determine a degree indicating the feature matching the particular rule (step 860). After step 860, determine if it is necessary to access the next particular rule. If it is necessary to access the next particular rule, then go back to step 830. If there is not, then calculate a result (step 880) and end the flow chart.

As described above, a situation about how the tooth is scraped is simulated. With some arrangements about detail course, an intern Doctor could shape the required teeth and be reviewed in this simulation system. However, the above description should not be treated as a limitation of the present invention. Relating axis positioning means and method for acquiring information should be notified as disclosed by the present invention. For instance, through the digitalization of the axis information, it is possible to monitor hand tool operation and review above operation through the Internet.

It is worth mentioning that medical technicians could use both hands, no matter right-handed or left-handed, to operate equipment. It's also capable of updating present equipment in hospitals and applying to the medical practice by adjusting prosecution.

Foregoing descriptions and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A dental clinical and simulation training tracking system, comprising:
a position unit, having a plurality of marked points and a hooking structure capable of setting on a tooth and upper and lower jaw model;
a hand tool socket, having a plurality of positioning points, casing to a hand tool;
an information processing unit, capable of processing information from elements among devices, building up a corresponding coordinate axis in all processing steps and storing records and results in all motion simulation;
a display unit, capable of displaying motions, positions and results reviewing user for operating the system; and
an optical positioning unit, at least comprising two cameras, wherein the cameras focusing on the position unit and the hand tool socket and is connected with the information processing device for acquiring the marked points on the position unit and the positioning points on the hand tool socket to generate an image, and the optical positioning unit further comprising:
a laser unit, connected with the information processing unit, brightening to define a choosing area.

2. The dental system according to claim 1, wherein the position unit at least comprising four 4 marked points constructed by Light Emitting Diode or optical reflecting marks.

3. The dental system according to claim 1, wherein motions and position in the tooth and upper and lower jaw model is constructed by the tooth and upper and lower jaw model using a resisted function adjusting for the coordinate axis of the positioning unit.

4. The dental system according to claim 3, wherein the positioning points of the hand tool socket are divided into an upper positioning points group and a lower positioning points group.

5. The dental system according to claim 4, wherein the arrangement of the position points of the hand tool socket is selected from an irregular arrangement, a crossing arrangement and a combination of above arrangements for avoiding the upper positioning points group and the lower positioning points group are covered at the same time.

6. The dental system according to claim 4, wherein the upper positioning points group and the lower positioning points group are forming a circular arrangement respectively.

7. The dental system according to claim 1, wherein the position points of the hand tool socket and the marked points of the positioning unit are selected from LED or optical reflecting marks.

8. The dental system according to claim 1, wherein the device further comprising a lamp arm, fixed the optical module in a positioning position.

9. The dental system according to claim 8, wherein the lamp arm further comprising a lighting unit, fixed on the lamp arm, for providing light source acquired for the dental clinical and simulation training tracking system.

10. The dental system according to claim 1, wherein the hand tool, applied for dental practice, is selected from a electrical driven drill or a air driven drill.

11. A dental clinical and simulation training tracking system, comprising:
a position unit, having a plurality of marked points and a hooking structure capable of setting on a tooth and upper and lower jaw model, wherein motions and position in the tooth and upper and lower jaw model is constructed by the tooth and upper and lower jaw model using a resisted function adjusting for the coordinate axis of the positioning unit;
a hand tool socket, having a plurality of positioning points, casing to a hand tool wherein the hand tool is applied for dental practice and selected from a electrical driven drill or a air driven drill;
an information processing unit, capable of processing information from elements among devices, building up a corresponding coordinate axis in all processing steps and storing records and results in all motion simulation;
a display unit, capable of displaying motions, positions and results reviewing user for operating the system; and
an optical positioning unit, at least comprising two cameras, wherein the cameras focusing on the position unit and the hand tool socket and is connected with the information processing device for acquiring the marked points on the position unit and the positioning points on the hand tool socket to generate an image, and the optical positioning unit further comprising:
a laser unit, connected with the information processing unit, brightening to define a choosing area;
a lamp arm, fixed the optical module in a positioning position; and
a lighting unit, fixed on the lamp arm for providing light source acquired for the dental clinical and simulation training tracking system.

12. The dental system according to claim 11, wherein the position points of the hand tool socket and the marked points of the positioning unit are selected from LED or optical reflecting marks.

13. The dental system according to claim 11, wherein the positioning points of the hand tool socket are divided into an upper positioning points group and a lower positioning points group.

14. The dental system according to claim 13, wherein the arrangement of the position points of the hand tool socket is selected from an irregular arrangement, a crossing arrangement and a combination of above arrangements for avoiding the upper positioning points group and the lower positioning points group are covered at the same time.

15. The dental system according to claim 13, wherein the upper positioning points group and the lower positioning points group are forming a circular arrangement respectively.

16. The dental system according to claim 11, wherein the position points of the hand tool socket and the marked points of the positioning unit are capable of applied by a light source with a particular wavelength, which could be set by a LED lamp.

17. A review method for dental clinical and simulation training tracking system, applying functions in the system to pre-set a review rule in the system and review user's degrees according to the review rule, at least comprising:
constructing a teeth module file through the dental clinical and simulation training tracking system;
quantificating the teeth module file through the dental clinical and simulation training tracking system;
determining if a serious mistake appears;
accessing a standard rule and a standard teeth module file;
generating a comparing figure between the standard teeth module file and the teeth module file;
finding a feature position set in the standard teeth module file;
calculating a degree if the feature matches the particular rule;
determining if there is no necessary to access next particular rule; and
calculating the review result.

18. The dental method according to claim 17, further comprising below steps:
constructing a standard teeth module file through a dental clinical and simulation training tracking system;
constructing a present teeth module file through a dental clinical and simulation training tracking system;
setting a position and an angle requiring to sampling;
generating a comparing figure between the standard teeth module file and the present teeth module file;
setting an important position and an angle for reviewing in the comparing figure;
generating a particular rule and storing to a data base; and
determining if there is no necessary to access next particular rule.

19. The dental method according to claim 18, wherein the important position and the angle for reviewing in the comparing figure is to emphasis a scraping amount, a scraping degree and a scraping angle.

20. The dental method according to claim 17, wherein the serious mistake means one of below situation is appeared in the scraping process: injuring neighbor teeth, injuring pulp of the teeth and scraping an area beyond the teeth.

21. The dental method according to claim 17, wherein the features is set according to different particular rule.
